(19) United States
(12) Patent Application Publication
(10) Pub. No.: US 2007/0146364 A1
(43) Pub. Date: Jun. 28, 2007

(54) METHODS AND SYSTEMS FOR DISPLAYING SHADED TERRAIN MAPS

(76) Inventor: Sven D. Aspen, Sherwood, OR (US)

Correspondence Address: JOHN S. BEULICK;ARMSTRONG TEASDALE LLP, ONE METROPOLITAN SQUARE, SUITE 2600, ST. LOUIS, MO, 63102-2740, US

(21) Appl. No.: 11/534,589

(22) Filed: Sep. 22, 2006

Related U.S. Application Data
(60) Provisional application No. 60/753,289, filed on Dec. 22, 2005.

(51) Int. Cl. G06T 15/50

(52) U.S. Cl. 345/426

(57) ABSTRACT

Methods and systems for a display system for an aircraft are provided. The system includes a moving map display screen configured to display a shaded-relief terrain display representative of an area being traversed by the aircraft, and a light source representation providing shading to the shaded-relief terrain display wherein the light source representation is oriented from a predetermined direction with respect to the screen regardless of the orientation of the shaded-relief terrain display on the display screen.

### CROSS REFERENCE TO RELATED APPLICATIONS

This application claims priority to U.S. Provisional Patent Application Ser. No. 60/753,289 filed Dec. 22, 2005, the contents of which are hereby incorporated by reference.

### BACKGROUND OF THE INVENTION

This invention relates generally to aircraft cockpit displays and more particularly, to methods and systems for displaying terrain maps on aircraft cockpit displays.

At least some known aircraft include cockpit displays using pre-composed shaded terrain charts in a course up mode. Course-up mode displays the chart with the aircraft's current heading or course over ground oriented towards the top of the display. As the aircraft's heading changes, the orientation of the shaded-relief terrain display changes correspondingly. The pre-composed shaded terrain charts use a light source for shading the terrain chart that is perceived to be in the upper left quadrant of the terrain chart. In cases where the heading of the aircraft changes and the orientation of the chart follows the heading changes, eventually the light source appears to be in other than the upper left quadrant. The perception in this case is a reversal effect wherein depressions in the original chart are perceived by the viewer as elevations, and elevations are perceived as depressions such that mountain ridges could be mistaken for valleys, and valleys for mountain ridges.

The human visual system has been trained to assume that the light source should always be from the upper left. Most windowing systems obtain a three-dimensional perspective for the user interface components by coloring the top and left edges light and the bottom and right edges dark. For north-up aeronautical charts, the upper left is northwest, thus hard-coding the azimuth of a light source vector for shaded-relief terrain depiction, a light source vector from the northwest is usually chosen. However, this hard-coded light source results in the adverse visual affects described above if the chart is rotated sufficiently to move the azimuth of the light source vector away from the upper left quadrant.

### BRIEF DESCRIPTION OF THE INVENTION

In one embodiment, a display system for an aircraft includes a moving map display screen configured to display a shaded-relief terrain display representative of an area being traversed by the aircraft, and a light source representation providing shading to the shaded-relief terrain display wherein the light source representation is oriented from a predetermined direction with respect to the screen regardless of the orientation of the shaded-relief terrain display on the display screen.

In another embodiment, a method of generating a shaded-relief terrain display includes storing a first shaded-relief terrain bitmap in a memory cache, determining whether an azimuth of a light source representation of the first shaded-relief terrain bitmap is located in an upper-left quadrant of the shaded-relief terrain display using a current rotation angle of the shaded-relief terrain display, if the azimuth of the light source representation of the first shaded-relief terrain bitmap is located in the upper-left quadrant of the shaded-relief terrain display, displaying the first shaded-relief terrain bitmap, if the azimuth of the light source representation of the first shaded-relief terrain bitmap is located outside the upper-left quadrant of the shaded-relief terrain display, generating a second shaded relief terrain bitmap using a current rotation angle using a light source representation located in the upper-left corner of the display, and storing the bitmap in a memory cache for subsequent display.

In yet another embodiment, a situational awareness system including a shaded-relief terrain display is provided. The system includes a database for storing data relating to a digital elevation model of a portion of the earth's surface wherein the model including a plurality of pixels. The digital elevation model includes a location coordinate and an elevation associated with each pixel; and a processor coupled to the database. The processor is configured to store a first shaded-relief terrain bitmap in a memory cache, determine whether an azimuth of a light source representation of the first shaded-relief terrain bitmap is located in an upper-left quadrant of the shaded-relief terrain display using a current rotation angle of the shaded-relief terrain display, if the azimuth of the light source representation of the first shaded-relief terrain bitmap is located in the upper-left quadrant of the shaded-relief terrain display, display the first shaded-relief terrain bitmap, if the azimuth of the light source representation of the first shaded-relief terrain bitmap is located outside the upper-left quadrant of the shaded-relief terrain display, generate a second shaded relief terrain bitmap using a current rotation angle using a light source representation located in the upper-left corner of the display, and store the bitmap in a memory cache for subsequent display.

### BRIEF DESCRIPTION OF THE DRAWINGS

FIG. 1 is a forward perspective view of an exemplary aircraft cockpit display panel that includes at least one display screen in accordance with an embodiment of the present invention;

FIG. 2 is a terrain image of an exemplary area of the earth's surface;

FIGS. 3A and 3B are illustrations of a computation of the dimming of exemplary pixels that may be used with terrain image, shown in FIG. 2, to provide a shaded terrain image;

FIG. 4A is an exemplary illustration 400 of a terrain map in a north-up orientation with the light source located in the upper left quadrant;

FIG. 4B an illustration of the terrain map shown in FIG. 4A rotated 180° such that the light source is maintained fixed in what is now the lower right quadrant;

FIG. 5A is an exemplary illustration of a terrain map in a north-up orientation with the light source located in the upper left quadrant

FIG. 5B an illustration of the terrain map shown in FIG. 5A rotated 180° such that the light source is maintained the upper left quadrant;

FIG. 6 is a flow chart of an exemplary method of generating a shaded-relief terrain display in accordance with an embodiment of the present invention.

### DETAILED DESCRIPTION OF THE INVENTION

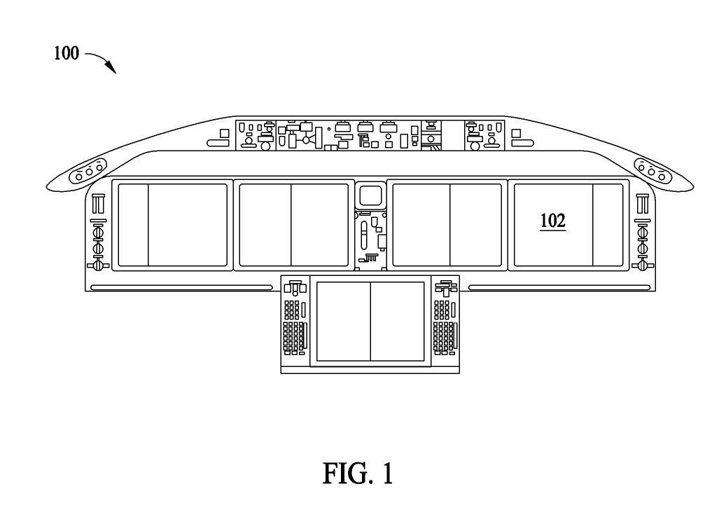

FIG. 1 is a forward perspective view of an exemplary aircraft cockpit display panel 100 that includes at least one display screen 102 in accordance with an embodiment of the present invention. In the exemplary embodiment, display screen is positioned on aircraft cockpit display panel 100. In an alternative embodiment, display screen 102 is positioned on an auxiliary panel (not shown) located in the cockpit of the aircraft. During aircraft operation, display screen 102 is available for viewing by a pilot and/or co-pilot of the aircraft. Display screen 102 may be used to view data included in an electronic flight bag (not shown), which may be embodied as a standalone device such as, but not limited to a PDA or laptop PC, or as a software component of a system executing on a processor that is part of a subsystem of the aircraft. In the exemplary embodiment, the electronic flight bag includes an electronic storage device configured to store various user-configurable flight-related objects for all required and desired information for a particular flight, such as flight routes, as defined by, for example, way-points, airport information, temporary flight restrictions, and weather information as well as any other user-defined objects associated with a flight, ground operations, and/or flight planning. The electronic flight bag receives data from various aircraft and ground sensors and systems, determines flight information based on the received data in real-time, and displays the flight information and/or alerts the flight crew through display screen 102 and other aural and/or visual indicators positioned on cockpit display panel 100. Such flight information provides the flight crew with additional situational awareness during all phases of aircraft operation.

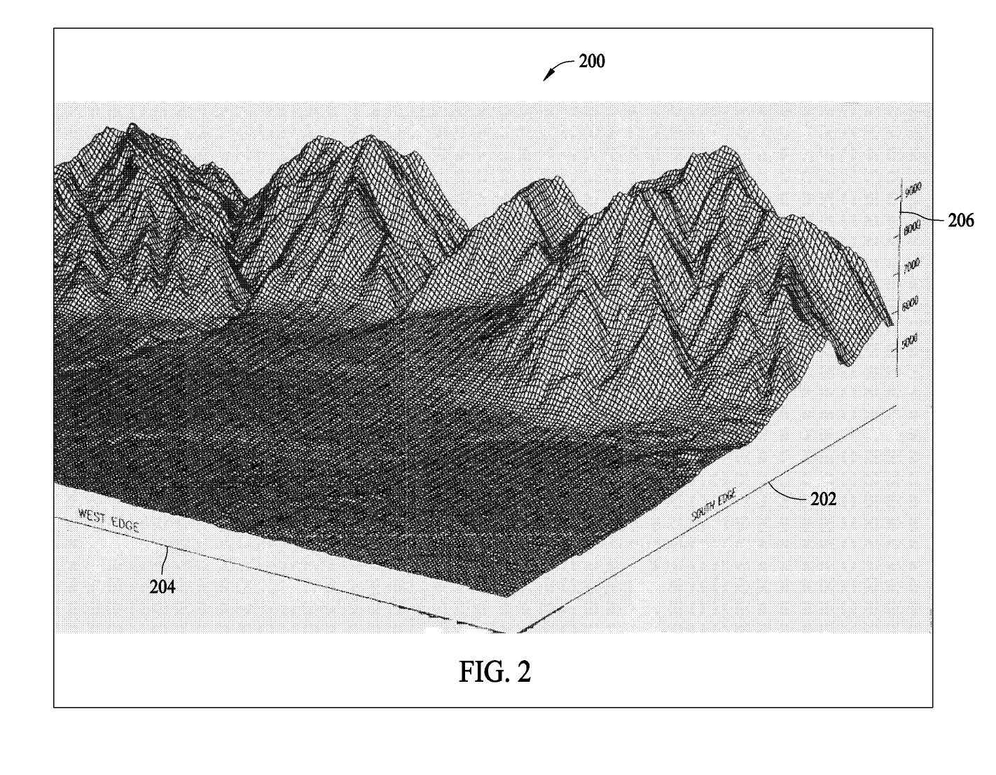

FIG. 2 is a terrain image 200 of an exemplary area of the earth's surface. Each point or pixel on terrain image 200 is defined by a location coordinate and an elevation. In one embodiment, each pixel on terrain image 200 is represented as a geographical location on a sphere centered on the center of the earth wherein the periphery of the sphere corresponds to mean sea level. In the exemplary embodiment, a Cartesian coordinate system is used, however the coordinate system is not limited to only a Cartesian system, but rather any suitable coordinate system capable of performing the functions described herein may be used. Each pixel is located at a junction of a value along a first axis 202 and a value along a second axis 204. The pixel is further defined by a value along a third axis 206 or elevation.

Shading of the terrain image permits the human eye to facilitate determining changes in elevation of terrain image 200 by rendering terrain image 200 in a more three-dimensional perspective. The shaded terrain image is created on a pixel-by-pixel basis by applying a “dimming” factor to each pixel based on the terrain image's reflectivity at that pixel. The dimming factor is applied by reducing the red, green, and blue (RGB) intensities of the base terrain image color. The base terrain color can either be a constant, or it can vary by elevation. Additionally the dimming factor may be applied to a grayscale intensity in the case of a monochrome terrain image. The reflectivity is determined by computing a normal vector for each terrain elevation pixel within terrain image 200, and performing a vector dot product between the normal vector and a light source vector. The closer the normalized dot product is to −1, the more reflective the terrain at that location, and the less the RGB intensities or grayscale intensity are reduced. Dot products greater than zero represent areas in the shade and have their intensities dimmed to an ambient light condition. Once computed, the bitmap containing terrain image 200 is cached in a memory such that subsequent redraws of terrain image 200 can occur in a short amount of time.

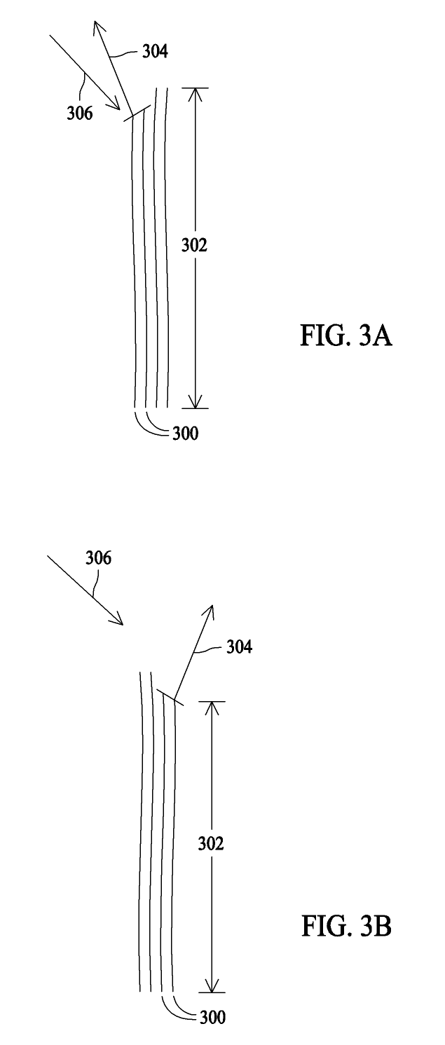

FIGS. 3A and 3B are illustrations of a computation of the dimming of exemplary pixels 300 that may be used with terrain image 200 (shown in FIG. 2) to provide a shaded terrain image. Each pixel 300 is represented by an elevation 302. From the respective elevations of adjacent pixels, a normal vector 304 for each pixel is determined. A dot product of normal vector 304 and a light source vector 306 is determined. The result is a scalar value that is used to determine the mount of dimming to be applied to the pixel. In FIG. 3A, the dot product of vector 304 and vector 306 is a negative number indicating a relatively high amount of reflectivity and a corresponding low amount of dimming is applied to the RGB intensity to illustrate the pixel is facing toward the light source. In FIG. 3B, the dot product of vector 304 and vector 306 is a positive number indicating the pixel is in the shade with respect to the light source and the intensity of the RGB intensity is dimmed to indicate to the viewer that the pixel is in the shade with respect to the light source.

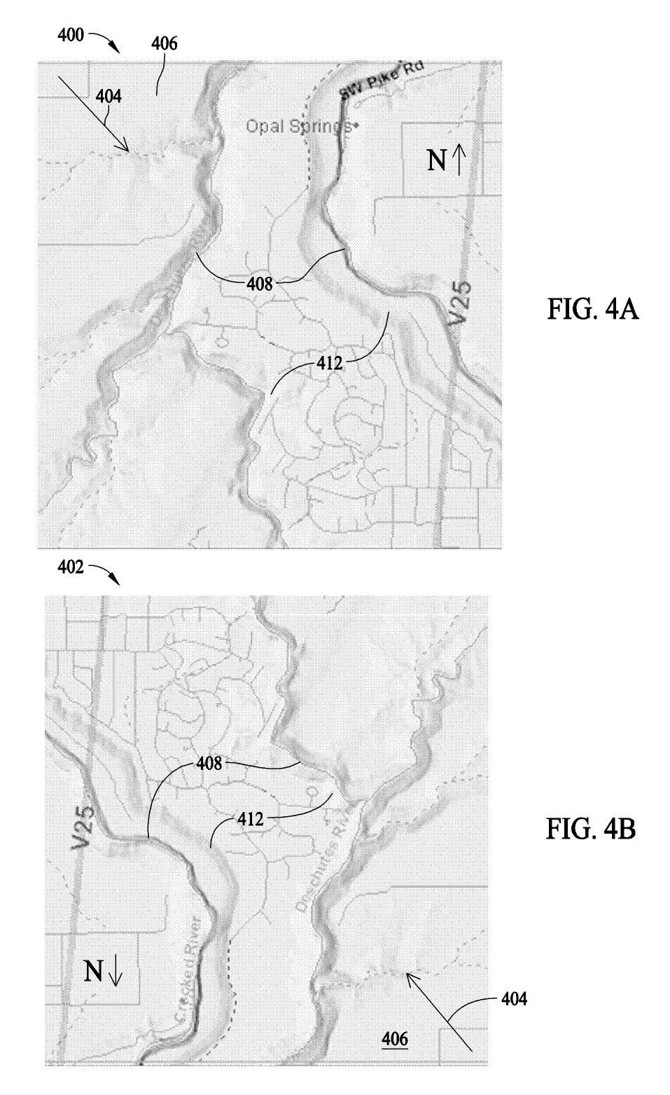

FIG. 4A is an exemplary illustration 400 of a terrain map in a north-up orientation with the light source located in the upper left quadrant. FIG. 4B an illustration 402 of the terrain map shown in FIG. 4A rotated 180° such that the light source is maintained fixed in what is now the lower right quadrant. In FIG. 4A, a light source vector 404 is selected to be originating in a quadrant 406 that is oriented in the upper left portion of the terrain map. Because the shading is rendered based on the light source being in the conventional position in the upper left quadrant, the rivers are perceived to be in the bottoms of canyons. In FIG. 4B, because the light source is hard coded into the terrain map image data, the light source is from the lower right quadrant when illustration 400 of the terrain map is rotated 180 degrees, and represents a course-up depiction if flying due south. Because the light source is hard-coded to be from the northwest, which is now to the bottom-right, rivers 408 are now perceived as being along the tops of ridges 412, which are not ridges but, rather are only perceived as ridges by the human visual system.

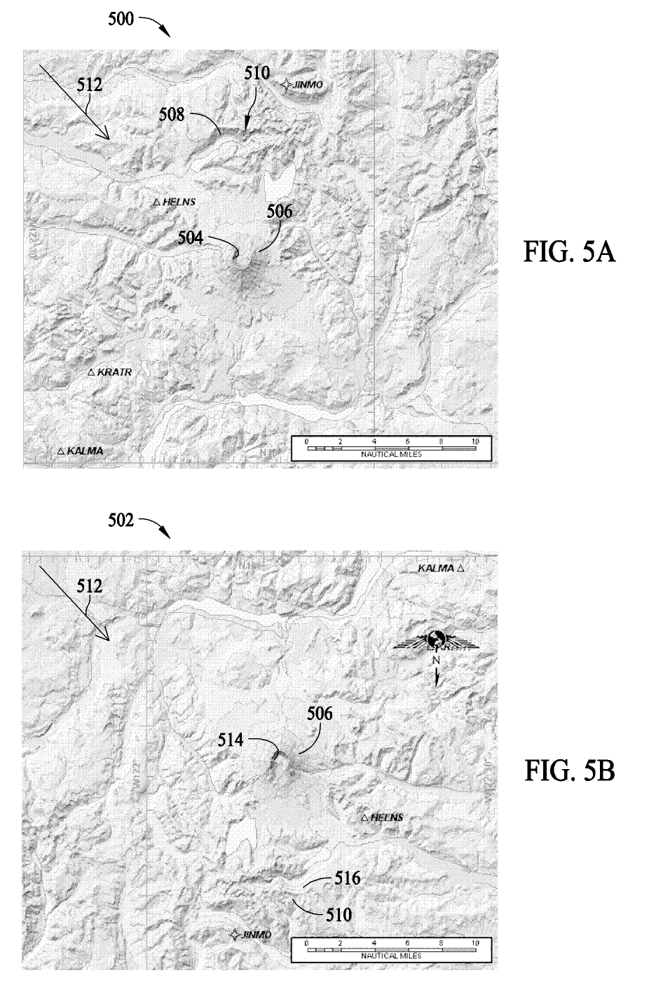

FIG. 5A is an exemplary illustration 500 of a terrain map in a north-up orientation with the light source located in the upper left quadrant. FIG. 5B an illustration 502 of the terrain map shown in FIG. 5A rotated 180° such that the light source is maintained the upper left quadrant. In FIG. 5A, the southeast faces of elevations and the northwest faces of depressions are dimmed to rendered the two dimensional image in a three dimensional perspective. For example, the northwest inner face 504 of the Mount St. Helens crater 506 and a southeast face 508 of a ridge 510 are dimmed. A light source vector 512 is illustrated as being from the upper left quadrant. FIG. 5B illustrates the same terrain map with the aircraft flying due south in a course-up mode. In accordance with various embodiments of the present invention light source vector is maintained in the upper left quadrant even though the aircraft is pointing 1800 from the direction in FIG. 5A. Maintaining light source vector 512 in the upper left quadrant while the terrain map is changing it's orientation with respect to the display requires recalculating the shading for all the pixels in the terrain map. In one embodiment, the shading of the terrain map is recalculated any time the course of the aircraft changes by a predetermined amount. In the exemplary embodiment, the shading of the terrain map is recalculated only when the light source vector reaches a limit of the upper left quadrant. Recalculating the shading near continuously renders a more accurate terrain map image but, at a heavy computational load on any processor. However, recalculating the shading of the terrain map less than continuously or only when the light source vector 512 reaches a limit of the upper left quadrant renders an adequately accurate terrain map image while reducing the computational load on the processor. In FIG. 5B, the illustration of the terrain map shown in FIG. 1 is shown in accordance with an embodiment of the present invention, such that when flying due south in a course up mode, light source vector 512 is maintained in the upper left quadrant of illustration 502. The southeast inner face 514 of the Mount St. Helens crater 506 is dimmed and a northwest face 516 of ridge 510 is not dimmed based on light source vector 512 being is illustrated as still being from the upper left quadrant, which is now from the southeast in FIG. 5B.

Various embodiments of the present invention dynamically renders shaded terrain relief where the light source positioned in the upper left quadrant of the display regardless of terrain map orientation. Such rendering permits the user to perceive a shaded terrain map (light source from upper left) correctly and not confuse valleys and mountains. Various embodiments of the present invention permit generating contours at any interval, using any color map, and using any light-source vector dynamically.

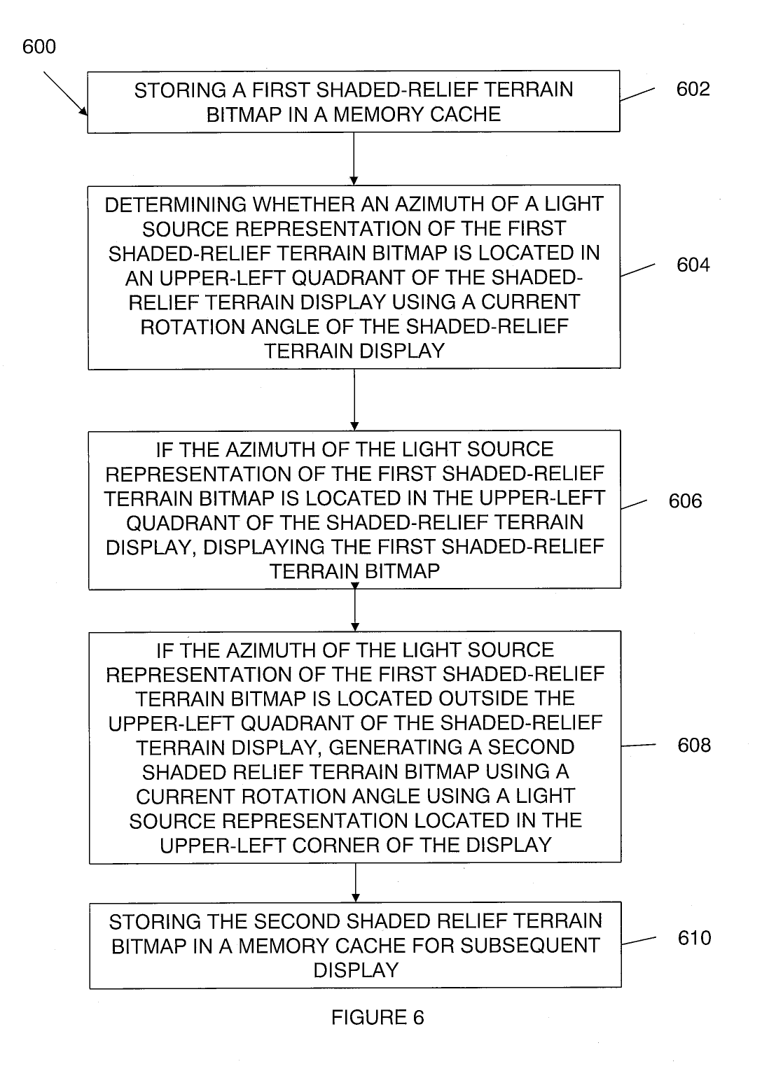

FIG. 6 is a flow chart of an exemplary method 600 of generating a shaded-relief terrain display in accordance with an embodiment of the present invention. Method 600 includes storing 602 a first shaded-relief terrain bitmap in a memory cache. The memory cache is communicatively coupled to a processor that is a part of for example, an electronic flight bag, a situational awareness system or other flight information system. The first shaded-relief terrain bitmap includes a light source representation that adds shaded features to the first shaded-relief terrain bitmap corresponding to the light source representation being in the upper left hand quadrant of a display of the first shaded-relief terrain bitmap. Method 600 also includes determining 604 whether an azimuth of the light source representation of the first shaded-relief terrain bitmap is located in an upper-left quadrant of the shaded-relief terrain display using a current rotation angle of the shaded-relief terrain display and if the azimuth of the light source representation of the first shaded-relief terrain bitmap is located in the upper-left quadrant of the shaded-relief terrain display, the first shaded-relief terrain bitmap stored in the memory cache is displayed 606. If the azimuth of the light source representation of the first shaded-relief terrain bitmap is located outside the upper-left quadrant of the shaded-relief terrain display, a second shaded relief terrain bitmap is generated 608 using a current rotation angle and a light source representation located in the upper-left corner of the display. The new bitmap is stored 610 in the memory cache for subsequent display.

In the shaded-relief terrain bitmaps, each pixel that is displayed as part of the shaded-relief terrain display is represented as a coordinate geographical location on a substantially spherical surface centered approximately on the center of the earth and as an elevation above a surface of the substantially spherical surface. As the aircraft changes course the shaded-relief terrain display changes by a corresponding amount. If the course is changed sufficiently such that the light source representation no longer appears to emanate from the upper left hand quadrant of the shaded-relief terrain display, ridges displayed on the shaded-relief terrain display may be perceived as valleys and vice versa as discussed above. To alleviate the potential misperception of the terrain features a new shaded-relief terrain bitmap is generated and displayed. The new bitmap is generated by selecting a new source representation vector from the upper left quadrant of the bitmap with respect to a current heading, determining a normal vector for the pixels in the bitmap, determining a shading factor for the pixels using the light source representation vector and the normal vector, and then storing the new shaded relief terrain bitmap in the memory cache. In the exemplary embodiment, the shading factor for the pixels is determined using a dot product of the light source vector and the respective normal vector for the pixels and assigning the scalar value of the dot product to the shading factor value for each respective pixel. The shaded-relief terrain map based on the new bitmap is displayed with the map orientation corresponding to the current heading and with the light source representation emanating from the upper left hand quadrant of the display.

The above-described methods and systems for generating a shaded-relief terrain map are cost-effective and highly reliable. Dynamic computation of shaded terrain information on-the-fly was typically considered not technically feasible due to its computational overhead. Embodiments of the present invention overcome the technical obstacles to dynamically generate shaded terrain images only when necessary to maintain proper visual perspective or when requested by a user, thus properly representing shaded terrain in a course-up or track-up chart orientation. The methods and systems facilitate navigation and situation awareness in a cost-effective and reliable manner.

While the invention has been described in terms of various specific embodiments, those skilled in the art will recognize that the invention can be practiced with modification within the spirit and scope of the claims.

What is claimed is:

1. A display system for an aircraft comprising:
a moving map display screen configured to display a shaded-relief terrain display representative of an area being traversed by the aircraft; and
a light source representation providing shading to the shaded-relief terrain display wherein said light source representation is oriented from a predetermined direction with respect to the screen regardless of the orientation of the shaded-relief terrain display on the display screen.

2. A system in accordance with claim 1 wherein said shaded-relief terrain display comprises a shaded two-dimensional representation of a three-dimensional terrain wherein the shading is configured to darken facets of the terrain that are facing away from the light source representation and to lighten facets a side of the terrain that are facing toward the light source representation.

3. A system in accordance with claim 1 wherein an orientation mode of the shaded-relief terrain display is selectable by a user.

4. A system in accordance with claim 1 wherein when the orientation mode of the shaded-relief terrain display is selected to a course orientation mode, the orientation of the shaded-relief terrain display corresponds to a course heading of the aircraft.

5. A system in accordance with claim 1 wherein said predetermined direction of the light source representation comprises a direction from an upper left position on the screen.

6. A system in accordance with claim 1 wherein said shaded-relief terrain display comprises a color map wherein predetermined color values are assigned to corresponding terrain elevation ranges.

7. A method of generating a shaded-relief terrain display comprising:
storing a first shaded-relief terrain bitmap in a memory cache;
determining whether an azimuth of a light source representation of the first shaded-relief terrain bitmap is located in an upper-left quadrant of the shaded-relief terrain display using a current rotation angle of the shaded-relief terrain display;
if the azimuth of the light source representation of the first shaded-relief terrain bitmap is located in the upper-left quadrant of the shaded-relief terrain display, displaying the first shaded-relief terrain bitmap;
if the azimuth of the light source representation of the first shaded-relief terrain bitmap is located outside the upper-left quadrant of the shaded-relief terrain display, generating a second shaded relief terrain bitmap using a current rotation angle using a light source representation located in the upper-left corner of the display; and
storing the bitmap in a memory cache for subsequent display.

8. A method in accordance with claim 7 wherein said storing a first shaded-relief terrain bitmap in a memory cache comprises representing each pixel of the shaded-relief terrain display as a geographical location on a sphere centered on the center of the earth and an elevation above a surface of the sphere.

9. A method in accordance with claim 7 wherein said generating a second shaded relief terrain bitmap comprises:
generating a relief terrain bitmap comprising a plurality of pixels, said bitmap based on a current location and heading of the aircraft;
selecting a first light source representation vector from the upper left quadrant of the bitmap;
determining a normal vector for at least one of the pixels;
determining a shading factor for the at least one of the pixels using the light source representation vector and the normal vector; and
storing the second shaded relief terrain bitmap in the memory cache.

10. A method in accordance with claim 9 wherein determining a shading factor for the at least one of the pixels comprises determining a dot product of the light source vector and the respective normal vector for the at least one of the pixels.

11. A method in accordance with claim 10 wherein determining a shading factor for the at least one of the pixels comprises assigning the scalar value of the dot product to the shading factor value for each respective pixel.

12. A situational awareness system including a shaded-relief terrain display comprising:
a database for storing data relating to a digital elevation model of a portion of the earth's surface, said model comprising a plurality of pixels, said digital elevation model including a location coordinate and an elevation associated with each pixel; and
a processor coupled to the database, the processor configured to:
store a first shaded-relief terrain bitmap in a memory cache;
determine whether an azimuth of a light source representation of the first shaded-relief terrain bitmap is located in an upper-left quadrant of the shaded-relief terrain display using a current rotation angle of the shaded-relief terrain display;
if the azimuth of the light source representation of the first shaded-relief terrain bitmap is located in the upper-left quadrant of the shaded-relief terrain display, display the first shaded-relief terrain bitmap;
if the azimuth of the light source representation of the first shaded-relief terrain bitmap is located outside the upper-left quadrant of the shaded-relief terrain display, generate a second shaded relief terrain bitmap using a current rotation angle using a light source representation located in the upper-left corner of the display; and
store the bitmap in a memory cache for subsequent display.

13. A system in accordance with claim 12 wherein said processor is further configured to receive the location coordinate and an elevation associated with at least one pixel;
determine a first light source vector associated with the shaded-relief terrain display;
determine a shading of the at least one pixel based on the location coordinate and the elevation associated with the at least one pixel and the light source vector;
display a shaded terrain map on the shaded-relief terrain display using the location coordinate, elevation, and the determined shading.

14. A system in accordance with claim 12 wherein said processor is further configured to determine a normal vector for the at least one pixel.

15. A system in accordance with claim 12 wherein said processor is further configured to determine a shading of the at least one pixel using a dot product of the normal vector and the light source vector.

16. A system in accordance with claim 12 wherein said processor is further configured to determine a second light source vector associated with the shaded-relief terrain display when the first light source vector moves outside an upper left quadrant of the shaded-relief terrain display.

17. A system in accordance with claim 12 wherein said processor is further configured to receive information relative to a light source vector from a user.

18. A system in accordance with claim 12 wherein said processor is further configured to determine the light source vector using a heading of the aircraft and a previous light source vector.

19. A system in accordance with claim 12 wherein said processor is further configured to:
determine a course of the aircraft;
alter a directional orientation of the shaded-relief terrain display in accordance with a corresponding change in course of the aircraft.

20. A system in accordance with claim 12 wherein said processor is further configured to store the shaded terrain map in a cache communicatively coupled to said processor.
